(19) United States
(12) Patent Application Publication
(10) Pub. No.: US 2014/0260829 A1
(43) Pub. Date: Sep. 18, 2014

(54) EXTENDABLE WRENCH

(71) Applicant: Peter Alfinito, Cherry Hill, NJ (US)

(72) Inventor: Peter Alfinito, Cherry Hill, NJ (US)

(21) Appl. No.: 13/838,285

(22) Filed: Mar. 15, 2013

(51) Int. Cl. B25B 23/00; B25B 29/00

(52) U.S. Cl. CPC B25B 23/0021; B25B 23/0007; B25B 29/00
USPC 81/177.2; 81/177.85; 29/428

(57) ABSTRACT

A tool for providing improved reach and torque is disclosed. The tool includes a wrench including a head, a wrench body coupled to said head, and a connector coupled to said wrench body distal to said head. The tool includes an extension including with an inserter and an extension body. Said inserter is configured to mate with said connector, and said extension increases the reach and torque of said tool. The wrench head may include any size or dimension.

### FIELD OF INVENTION

This application is generally related to hand tools and more particularly related to wrenches.

### BACKGROUND

Existing wrenches are traditionally double ended tools that have generally accepted standard and metric measurements. There are varying types of wrenches, which may include different head portions at each end of the wrench. Some combinations include open/closed, closed, open/open, open/ratchet, and closed/ratchet. Existing sets of wrench sets typically include a large number of wrench sizes with varying body lengths. Users may engage one of the ends of the wrenches with a makeshift lever, pipe, or hollow tube to increase the length of existing wrenches. These makeshift levers are unreliable due to unsecure attachment between the makeshift lever and the end of the wrench. Further, multiple makeshift levers are needed due to the varying sizes of the wrenches and the use of these makeshift levers may cause damage to the unused end of the wrench.

Ratchet sets were developed with the ability to interchange socket fittings via a standardized interlocking, which is typically a square male and female configuration, secured by a ball bearing component. Extensions for ratchet seats are used for extending the length of the connection between the ratchet and the socket.

The amount of torque applied to a bolt by a wrench is equal to the amount of force applied to the handle of the wrench multiplied by the distance between the bolt and the force application point on the handle of the tool. Increasing the distance between the bolt and the force application point on the handle of the tool increases the torque applied to the bolt for a given applied force.

Therefore, a need exists for a wrench that includes interchangeable wrench sizes and types and extensions to improve both the reach and torque of the wrench.

### SUMMARY

A tool for providing improved reach and torque is provided. The tool includes a wrench including a head, a wrench body coupled to the head, and a connector coupled to the wrench body distal to the head. The tool includes an extension including an inserter and an extension body. The inserter is configured to mate with the connector, and the extension increases the reach and torque of the tool.

A method for increasing the reach and torque of a wrench is provided. The method includes attaching at least one extension to a connector of the wrench, wherein the at least one extension includes an inserter configured to mate with the wrench connector to provide the wrench with increased reach and torque.

A system for providing improved reach and torque is provided. The system includes a plurality of wrenches, each wrench including a head, a wrench body coupled to the head, and a connector coupled to the wrench body distal to the head. The wrench heads may be in different configurations. The system includes a plurality of extensions, each extension including an inserter and an extension body. The extension bodies from ones of the plurality of extensions may be different lengths. Each inserter is configured to mate with each of the connectors, and the extensions increase the reach and torque of the wrench.

### BRIEF DESCRIPTION OF THE DRAWINGS

FIG. 1 is a side view of a wrench and extension according to the invention.

FIG. 2 is side view of the wrench and extension immediately prior to matingly engaging.

FIG. 3 is a side view of the wrench according to the invention.

FIG. 4 is a side view of two different extensions.

FIG. 5 is a flow diagram of a method of the invention.

FIG. 6 is a side view of a plurality of wrenches and extensions according to the invention.

FIG. 7 is a side view of the wrench and connector showing the lengths of the components.

FIG. 8 is a force diagram of a connector and inserter according to the invention.

### DETAILED DESCRIPTION OF THE PREFERRED EMBODIMENTS

Certain terminology is used in the following description for convenience only and is not limiting. The words “inner,” “outer,” “inwardly,” and “outwardly” refer to directions towards and away from the parts referenced in the drawings. A reference to a list of items that are cited as “at least one of a, b, or c” (where a, b, and c represent the items being listed) means any single one of the items a, b, c or combinations thereof. The terminology includes the words specifically noted above, derivates thereof, and words of similar import.

FIG. 1 shows an embodiment of the tool according to the present invention. As shown, additionally with reference to FIG. 3, the tool includes a wrench 10 with a head 12, a connector 14, and a body 16. The head 12 of the wrench 10 may include the head 12 of any type of wrench, including a box wrench, open end wrench, ratchet wrench, flare-nut wrench, tube wrench, line wrench, ratcheting wrench, adjustable wrench, torque wrench, alligator wrench, cone wrench, or any other wrench type. The head 12 of the wrench 10 may be substantially co-planar with the planar surface of the wrench body 16. The head 12 of the wrench 10 may be offset from a planar surface of the wrench body 16. The wrench body 16 may be any length. The wrench connector 14 is configured to matingly engage with an inserter 22 of an extension 20. The inserter 22 may be triangular, quadrilateral, pentagonal, hexagonal, or any other shape. The wrench connector 14 has a corresponding configuration to matingly engage, or otherwise receive, the inserter 22. One extension 20 type that is commonly used in tools that may be utilized in an embodiment of the tool described herein, may be the extension used in a ratchet tool set. Such an extension employs a square inserter and corresponding receiver configuration to matingly engage the square inserter. The inserter and the corresponding receiver may be triangular or round. The inserter may be a propriety shape and the connector may be a corresponding propriety shape. A proprietary shape may include a triangular, star, pentagonal, circular, or other polygonal shape.

In an embodiment, a tool for providing improved reach and torque is provided. The tool includes a wrench 10 including a head 12, a wrench body 16 coupled to the head 12, and a connector 14 coupled to the wrench body 16 distal to the head 12. The head 12 may be selected from a plurality of sizes including American and English units. The head 12 may be selected from a plurality of types of wrench heads. The head 12 may be co-planar or offset from a planar surface of the wrench body 16. The tool includes an extension 20 including an inserter 22 and an extension body 26. The inserter 22 is configured to mate with the connector 14, and the extension 20 increases the reach and torque of the tool. The connector 14 and the inserter 22 may be matingly coupled via a locking mechanism. The locking mechanism may include any suitable locking configuration for connecting the connector 14 and the inserter 22. The connector 14 and the inserter 22 may be matingly coupled via a bearing locking mechanism 28. The inserter 22 may be square and may include a bearing locking mechanism 28. The connector 14 may include a correspondingly shaped receiving portion for the inserter 22. The connector 14 and inserter 22 may include any shapes for matingly engaging with each other. An additional extension 30 may be provided that matingly engages the extension 20 distal to the inserter 22 for providing additional reach and torque of the tool. The additional extension 30 may be a different length than the extension 20. The extension 20 may include a connector 24 distal to the inserter 22. The additional extension 30 may include a second inserter 32. The additional extension 30 may matingly engage the connector 24 of the extension 20 with the second inserter 32. The extension connector 24 and the wrench connector 14 may be operatively identical. The extension inserter 22 and the second inserter may be operatively identical. The inserter 22 may be a proprietary shape and may include a bearing locking mechanism 28. The connector 24 may include a correspondingly shaped receiving portion for the inserter 22.

In an embodiment, a wrench 10 for providing improved reach and torque is provided. The wrench 10 includes a head 12, a wrench body 16 coupled to the head 12, and a connector 14 coupled to the wrench body 16 distal to the head 12. The connector 14 is configured to mate with an inserter 22 of an extension 20 to increase the reach and torque of the wrench 10. Any suitable extension may be inserted into the connector 14 on the wrench 10.

FIG. 2 shows the wrench 10 and extension 20 just prior to matingly engaging with each other. The extension 20 includes the inserter 22, a receiving portion, and a body portion 26. The inserter 22 may include a locking mechanism 28. The locking mechanism 28 may include a bearing element that is spring loaded for engaging the connector 14. The connector 14 may include a detent recess, slot, groove, or other component to receive the locking mechanism 28 bearing element. The locking mechanism/detent recess is described herein as being on the extension/connector respectively. However, the mechanism and detent recess may be switched in location. That is, the mechanism may be on the connector 22 and the projection 28 on the extension 20. The extension body 26 may be of any length. As shown in FIG. 4, a plurality of extensions 20, 30 may be provided of varying lengths such that the reach and torque of the connected tool is increased and selectively varied. The receiving portion 24 of the first extension 20 may be matingly engaged with a second inserter 32 of a second extension 30 to provide additional reach and torque to the tool. Multiple extensions may be matingly engaged with each other to increase the reach and torque of the tool.

FIG. 6 shows a set of wrenches and extensions that may be included in a tool set. Multiple types of wrenches are shown along with different length extensions. In one embodiment, the coupling arrangement of the wrench 10 to the extension may be reversed. The connector 14 of the wrench 10 may be an insertion type and the coupling end of the extension 20 may be the receiving portion.

In an embodiment, a system for providing improved reach and torque is provided. The system includes a plurality of wrenches 110, 120, 130, 140. Each wrench 110, 120, 130, 140 includes a head 112, 122, 132, 142, a wrench body 116, 126, 136, 146 coupled to the head, and a connector 114, 124, 134, 144 coupled to the wrench body 116, 126, 136, 146 distal to the head 112, 122, 132, 1442. The wrench heads 112, 122, 132, 142 may be one of a plurality of different configurations. The system includes a plurality of extensions 20, 30. Each extension 20, 30 includes an inserter 22, 32 and an extension body 26, 36. The extension bodies 26, 36 may be different lengths. Each inserter 22, 32 is configured to mate with all of the connectors 114, 124, 134, 144, and the extensions 20, 30 increase the reach and torque of the wrench. Different configurations of wrench heads 112, 122, 132, 142 may be provided and may include different wrench heads 112, 122, 132, 142 capable of coupling to different sized and/or types of nuts. The connector 14 and the inserter 22 may be matingly coupled via a bearing locking mechanism 28. The inserter 22 may be square and may include a bearing locking mechanism 28. The connector 14 may include a correspondingly shaped receiving portion for the inserter 22. The extension connector 24 and the wrench connector 14 may be operatively identical. The extension inserter 22 and the additional extension inserter 32 may be operatively identical. The inserter 22 may be a proprietary shape and may include a bearing locking mechanism 28. The connector 14 may include a correspondingly shaped receiving portion for the inserter 22. The extension 20 may include an angled or curved body 26. The inserter 22 or connector 24 of the extension 20 may be angled with respect to the body 26 of the extension 20.

As shown in FIG. 5, a method 80 for increasing reach and torque of a tool, such as the tool described herein, is disclosed. The method 80 includes attaching an extension 20 to a connector 14 of the wrench 10 at step 82. The extension 20 includes an inserter 22 configured to mate with the wrench connector 14 to provide the wrench 10 with increased reach and torque. The method 80 includes reaching the attached wrench 10 and extension 20 to engage a nut at step 84. The method 80 includes applying force to the extension 20 and applying increased torque to the nut via the attached wrench 10 and extension 20 at step 86. Multiple extensions 20, 30 may be engaged with each other and the wrench 10 to apply more torque to the nut.

As shown in FIG. 7, the wrench 10 has a length L_{W}, the extension 20 has a length L_{E} and the tool, as assembled, has a total length of L_{T}. Torque is a measure of the turning force on an object, i.e. a nut or bolt. Torque is based on the length of a tool and the force applied to the end of that tool. Because torque is based on the total length of a tool, the increased length of the tool L_{T} compared to the length of the wrench L_{W} results in the tool being capable of applying an increased torque to a bolt as compared to the wrench 10. If only the wrench 10 is used to apply torque to the nut, the torque would equal the amount of force applied to the end of the wrench multiplied by L_{W}. Once the extension 20 engages the wrench 10, the torque applied to the nut is increased because the length of the tool is increased from L_{W} to L_{T}. Multiple additional extensions 20, 30 of longer or shorter lengths than the length of the extension L_{E} may be added to the tool to vary the torque of the tool. Any combination of extensions may be added to the tool to achieve any desired reach or torque of the tool.

As shown in FIG. 8, which shows a square inserter and corresponding square connector by way of example, the force applied on the extension F1 causes a concentration of force on a side wall at an axial end of the inserter. An opposing force to F1 is shown as F3 and is concentrated on an opposite side wall at a base of the inserter. A corresponding force to F1 is concentrated on a side wall of the connector and is shown as F2. A corresponding force to F3 is concentrated on a side wall of the connector near the axial end of the wrench and is shown as F4. These forces coupled the force applied to the extension to the wrench and wrench head, and therefore to the bolt or nut. This concentration of forces is shown for a square inserter/connector in which the wrench head is oriented in a plane that is parallel to two side walls of the inserter and connector. Other configurations of the inserter/connector are possible, as noted above. The side walls of the inserter and connector may be rotated by 45° such that when the extension is rotated to apply torque to a bolt, the associated forces are concentrated at a point where the side walls of the inserter intersect. The inserter and connector may be triangular, pentagonal, star shaped, circular, or other polygonal shape. The shapes of the inserter and the connector may be adapted to apply additional torque as needed within generally accepted engineering principles. The shape of the inserter and connector may be selected to ensure the stress concentrations from the force of the torque applied to the tool do not cause mechanical failure of the tool. The shapes of the inserter and connector may be aligned such that the surfaces of the inserter and connector that engage one another may be aligned with an axis of force. This may be beneficial to distribute stress concentrations across the engaging surfaces of the insert and connector.

Other tools, besides wrenches, may be used to apply the principles described above for providing additional reach and torque through the use of extensions. The ends of tools may be configured to matingly engage with extensions.

Having thus described various embodiments of the tool in detail, it is to be appreciated and will be apparent to those skilled in the art that many physical changes, only a few of which are exemplified in the detailed description above, could be made in the apparatus without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

1. A tool for providing improved reach and torque, comprising:
a wrench including a head, a wrench body coupled to said head, and a connector coupled to said wrench body distal to said head; and
an extension including an inserter and an extension body, wherein said inserter is configured to mate with said connector, and said extension increases the reach and torque of said tool.

2. The tool of claim 1 wherein said head is selected from a plurality of sizes.

3. The tool of claim 1 wherein said head is selected from a plurality of types of wrench heads.

4. The tool of claim 1, wherein said head is offset from a planar surface of said wrench body.

5. The tool of claim 1, wherein said connector and said inserter are matingly coupled via a bearing locking mechanism.

6. The tool of claim 1, wherein said inserter is square and includes a bearing locking mechanism, and said connector includes a correspondingly shaped receiving portion for said inserter.

7. The tool of claim 1, further comprising at least one additional extension that matingly engages said extension distal to said inserter for providing additional reach and torque of said tool.

8. The tool of claim 7 wherein said extension includes a connector distal to said inserter, and said at least one additional extension includes a second inserter, and said at least one additional extension matingly engages said connector of said extension with said second inserter.

9. The tool of claim 8 wherein said extension connector and said wrench connector are operatively identical.

10. The tool of claim 8 wherein said extension inserter and said second inserter are operatively identical.

11. The tool of claim 7, wherein said at least one additional extension is a different length than said extension.

12. The tool of claim 1, wherein said inserter is a proprietary shape and includes a bearing locking mechanism, and said connector includes a correspondingly shaped receiving portion for said inserter.

13. A wrench for providing improved reach and torque, comprising:
a head, a wrench body coupled to said head, and a connector coupled to said wrench body distal to said head, wherein said connector is configured to mate with an inserter of an extension to increase the reach and torque of said wrench.

14. A method for increasing the reach and toque of a wrench, comprising:
attaching at least one extension to a connector of said wrench, wherein said at least one extension includes an inserter configured to mate with said wrench connector to provide said wrench with increased reach and torque.

15. A system for providing improved reach and torque, comprising:
a plurality of wrenches, each wrench including a head, a wrench body coupled to said head, and a connector coupled to said wrench body distal to said head, wherein said wrench heads are different configurations;
a plurality of extensions, each extension including an inserter and an extension body, wherein said extension bodies are different lengths; and
wherein each said inserter is configured to mate with all said connectors, and said extensions increase the reach and torque of said wrench.

16. The system of claim 15 wherein different configurations of wrench heads includes different wrench heads capable of coupling to different sized nuts.

17. The system of claim 15 wherein said connector and said inserter are matingly coupled via a bearing locking mechanism.

18. The system of claim 15 wherein said inserter is square and includes a bearing locking mechanism, and said connector includes a correspondingly shaped receiving portion for said inserter.

19. The system of claim 15 wherein said extension connector and said wrench connector are operatively identical.

20. The system of claim 15 wherein said extension inserter and said at least one additional extension inserter are operatively identical.

21. The system of claim 15 wherein said inserter is a proprietary shape and includes a bearing locking mechanism, and said connector includes a correspondingly shaped receiving portion for said inserter.
